(19) United States
(12) Patent Application Publication
(10) Pub. No.: US 2017/0120756 A1
(43) Pub. Date: May 4, 2017

(54) VEHICLE EQUIPPED WITH ENGINE FOR DRIVING A GENERATOR

(71) Applicant: Mazda Motor Corporation, Hiroshima (JP)

(72) Inventors: Tetsuya Yokoyama, Higashihiroshima-shi (JP); Ryoji Kagawa, Hiroshima-shi (JP)

(21) Appl. No.: 15/294,008

(22) Filed: Oct. 14, 2016

(30) Foreign Application Priority Data
Oct. 30, 2015 (JP) 2015-214774

(51) Int. Cl. B60L 11/02; F02N 11/08; H02K 7/18; F01N 3/20

(52) U.S. Cl. CPC B60L 11/02; F01N 3/2013; F02N 11/08; H02K 7/1815

(57) ABSTRACT

To control the degradation of the emission performance when starting an engine on a vehicle equipped with an engine for driving a generator, the vehicle comprises a generator, an engine, and a catalyst device, a control unit (PCU) that is configured to execute a power generating operation mode after executing an initial mode to activate the catalyst device by operating an electric heater (EHC) when the generator starts power generation by starting the engine, a connecting passage (EGR passage) that connects mutually an intake passage and an exhaust passage, and an adjusting valve (a throttle valve, an exhaust shutter valve, and an EGR valve) for adjusting a flow rate of the gas in the connecting passage. The control unit performs motoring of the engine in the reverse rotation direction by the generator in the initial mode.

### FIELD OF THE INVENTION

The technology disclosed herein relates to a vehicle equipped with an engine for driving a generator.

### BACKGROUND ART

In Patent Document 1, a vehicle equipped with a catalyst device with an electric heater is described. On this vehicle, while a first catalyst part is arranged upstream of an exhaust passage, a second catalyst part is arranged downstream of the first catalyst part. An electric heater is installed upstream of the first catalyst. In a state in which exhaust gas that is exhausted from the engine by driving the engine is flowing in the exhaust passage, by heating the first catalyst part with an electric heater, the first catalyst part is activated.

### RELATED ART

### Patent Document

[Patent Document 1]

Japanese Unexamined Patent Application Publication No. H9-85054

### SUMMARY OF THE INVENTION

### Problems to be Solved by the Invention

Meanwhile, a vehicle equipped with a generator that is configured to generate electric power for driving and an engine that is configured to drive the generator may start the engine in a state in which a catalyst device is inactive during driving. Specifically, the generator of an electric vehicle equipped with a range extender device to extend a driving distance or a so-called plug-in hybrid vehicle starts power generation by starting the engine when a battery SOC (State Of Charge) is low. In these vehicles, because the starting frequency of the engine is low, a catalyst device is mostly inactive when the engine starts. When the catalyst device is still inactive, if the engine output is increased to the degree to which the generator generates power, the emission is exhausted into the atmosphere. When starting the engine, an emission performance is degraded.

The purpose of the technology disclosed herein in view of the above problems is to control the degradation of the emission performance when starting the engine of a vehicle that is equipped with an engine for driving the generator.

### BRIEF SUMMARY OF THE INVENTION

The technology disclosed herein relates to a vehicle equipped with an engine for driving a generator. This vehicle may comprise a generator mounted to the vehicle for generating electric power for driving, an engine connected to the generator for driving the generator, a catalyst device provided on an exhaust passage of the engine for purifying the exhaust gas exhausted from the engine when operating the engine, an electric heater provided on the exhaust passage for heating the catalyst device, and a control unit including a processor for executing a power generating operation mode to drive the generator by driving the engine after executing an initial mode to activate the catalyst device by operating the electric heater when the generator starts power generation by starting the engine.

The electric heater may be provided downstream of the catalyst device, and the generator may be configured to drive the engine. The vehicle may further comprise a connecting passage for mutually connecting an intake passage and the exhaust passage of the engine and an adjusting valve for adjusting a flow rate of the gas flowing in the connecting passage.

Moreover, the control unit may be configured to execute motoring of the engine in a reverse rotation direction via the generator while the electric heater is operated in the initial mode and adjusting the gas flow rate in the connecting passage via the adjusting valve.

In addition, the term “downstream” as used herein is defined by a flow direction of gas when the engine performs a normal operation.

According to this configuration, in order to start power generation by the generator, when starting the engine, the initial mode is executed before the power generating operation mode. The initial mode is a mode that activates the catalyst device by heating the catalyst device via the electric heater. In the initial mode, while the gas flow rate in the connecting passage that is connected between the intake passage and the exhaust passage is adjusted by the adjusting valve, motoring of the engine is performed in the reverse rotation direction by the generator. In the initial mode, the engine is not operated. Moreover, the operation referred to here is to supply fuel to the engine and operate the engine by combusting the fuel. In the initial mode, the exhaust gas is not exhausted by the engine, so that the degradation of the emission performance is prevented.

In the initial mode, as mentioned above, motoring of the engine is performed in the reverse rotation direction. Accordingly, the gas circulates to return from the engine through the intake passage, the connecting passage, and the exhaust passage to the engine. The adjusting valve here includes not only a valve that is provided on the connecting passage and opens and closes the connecting passage but also a valve (for example, a throttle valve) that is provided on the intake passage and opens and closes the intake passage so as to configure a gas circulation route, and/or a valve (for example, an exhaust shutter valve) that is provided on the exhaust passage and opens and closes the exhaust passage.

Since the electric heater is provided on the downstream of the catalyst device, the heat of the electric heater is sent to the catalyst device by the reverse gas flow at the time of the normal operation of the engine. Accordingly, the catalyst device is heated. Moreover, the gas heated by the electric heater reaches the electric heater again through the engine, the intake passage, and the connecting passage after passing through the catalyst device, and is heated again by the electric heater and sent to the catalyst device. Accordingly, by circulating the gas, the catalyst device can be raised in temperature efficiently and the catalyst device can be activated early.

Moreover, by making the gas circulation flow in the initial mode in the reverse direction of the time of the normal operation of the engine, the floating oil mist in the engine is exhausted to the intake passage side when motoring the engine. Accordingly, introduction of the oil mist to the catalyst device is controlled and preventing the degradation of the catalyst device is possible.

In the initial mode, after activating the catalyst device (for example, after the catalyst device is activated), the engine is operated and the power generating operation mode to drive the generator is executed. In the power generating operation mode, since the purification rate of the catalyst device is increased, the degradation of the emission performance is prevented even though the engine is operated.

Accordingly, when substantially starting power generation of the generator by starting the engine, by executing the initial mode before this start of the power generation, the degradation of the emission performance is prevented. Moreover, the power generation of the generator can be started promptly.

A temperature sensor may be provided on the intake passage for detecting a temperature of the gas flowing in the intake passage, and the control unit may be configured to detect a failure of the electric heater based on a detection result of the temperature sensor during the execution of the initial mode.

As described above, in the initial mode, the gas heated by the electric heater flows from the catalyst device through the engine to the intake passage. Therefore, by the detection by the temperature sensor provided on the intake passage, it is possible to detect whether the temperature of the gas flowing in the intake passage during the initial mode is increased or not. Depending on whether the gas temperature is increased or not, it is possible to detect whether the electric heater is operating normally or not (that is, not heated). This configuration has an advantage that the fault determination of the electric heater related to the exhaust emission performance is possible during the initial mode before starting the engine.

The catalyst device may comprise a front stage catalyst part and a rear stage catalyst part that is provided further downstream than the front stage catalyst part, the electric heater is provided between the front stage catalyst part and the rear stage catalyst part, and the control unit is configured to execute the power generating operation mode after the front stage catalyst part achieves an active state in the initial mode.

By providing the electric heater between the front stage catalyst part and the rear stage catalyst part, on the gas circulation flow in the initial mode, the front stage catalyst part that is directly upstream of the electric heater can be activated early.

Therefore, if the front stage catalyst part is in the active state, the power generating operation mode is executed, so that the power generation by the generator can be started promptly. In the power generating operation mode, the engine operates; however, since the front stage catalyst part is in the active state, the degradation of the emission performance is controlled. Moreover, in the power generating operation mode, since the engine output is increased to the degree to which the generator generates power, the temperature of the exhaust gas is increased. Accordingly, the rear stage catalyst part is also activated promptly. If the rear stage catalyst part is activated, the emission performance is improved.

The connecting passage may be connected downstream of the rear stage catalyst part on the exhaust passage. Accordingly, in the initial mode, since the gas circulates in the rear stage catalyst part and the front stage catalyst part, the rear stage catalyst part and the front stage catalyst part are activated respectively.

The connecting passage may be connected between the front stage catalyst part and the rear stage catalyst part on the exhaust passage. Accordingly, in the initial mode, since the gas circulates in the front stage catalyst part, the front stage catalyst part is activated. In this configuration, since the path length that the gas circulates is relatively short in the initial mode, the front stage catalyst part can be activated early. The power generation by the generator starts early.

In the intake passage, a storage part is provided between a cylinder inlet of the engine and a connecting part of the connecting passage on the intake passage for storing oil mist.

As described above, in the initial mode, the floating oil mist in the engine is exhausted to the intake passage side when motoring the engine. Since the gas circulates and flows at the time of the initial mode, it is possible that the oil mist reaches the exhaust passage from the connecting passage and enters an electric heater and/or the catalyst device.

In the configuration, the storage part is provided between the cylinder inlet of the engine and the connecting part of the connecting passage on the intake passage for storing oil mist. Accordingly, the oil mist is prevented from entering to the electric heater and/or the catalyst device.

The engine may be a rotary piston engine that is configured to supply metering oil to a sealing face in the engine.

The rotary piston engine also needs to supply metering oil to the sealing face in the engine when motoring. As described above, when motoring the rotary piston engine in the initial mode, the amount of the oil mist in the engine may possibly be larger than that of the reciprocating engine. Thus, when motoring in the initial mode, motoring the rotary piston engine in the reverse rotation direction is especially effective at preventing oil mist from entering the catalyst device.

When starting the power generating operation mode, the control unit may be configured to start fuel supply to the engine after motoring the engine in the normal rotation direction by the generator.

Accordingly, the engine can be started smoothly and certainly from the state of motoring the engine in the reverse rotation direction.

Moreover, the technology disclosed herein is suitable for a range extender electric vehicle in which the number of starts of the engine is low. In addition, the technology disclosed herein can be applied to a plug-in hybrid vehicle in which the number of starts of the engine is low as well as the range extender electric vehicle.

### EFFECTS OF THE INVENTION

As described above, the vehicle equipped with an engine for driving a generator, when starting the engine to start power generation by the generator, by executing the initial mode in which the catalyst device is activated, can promptly start power generation by the generator while activating the catalyst device while preventing degradation of the emission performance.

### BRIEF DESCRIPTION OF THE DRAWINGS

FIG. 1 is a drawing explaining a configuration of a vehicle equipped an engine for driving a generator.

FIG. 2 is a drawing explaining a configuration of a range extender device.

FIG. 3 is a drawing showing a configuration of a storage part provided on an intake passage.

FIG. 4 is a block diagram showing a configuration related to control of the range extender device.

FIG. 5 is a timing diagram of an engine start flag, an engine operating state, an EHC operating state, a fuel injection state, and a catalyst temperature when starting power generation by the generator.

FIG. 6 is a drawing explaining a configuration of a range extender device that is different from that in FIG. 2.

### DETAILED DESCRIPTION OF THE EMBODIMENTS

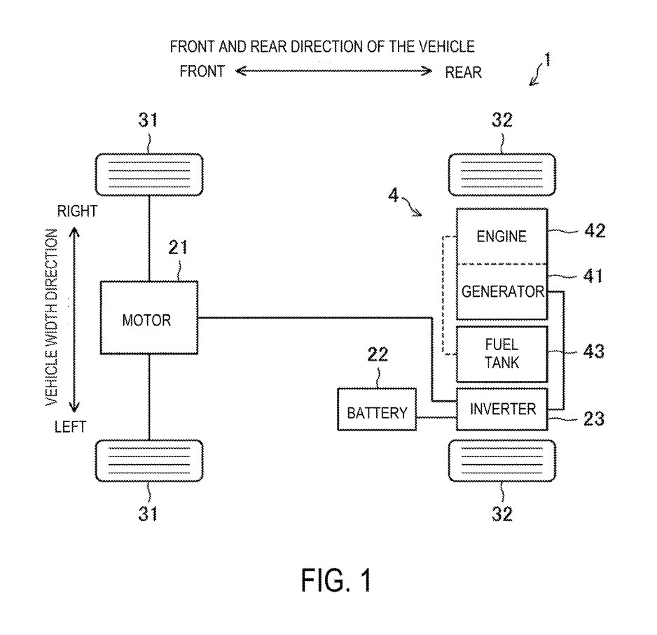

Hereinafter, the vehicle equipped an engine for driving a generator disclosed herein will be explained with reference to the drawings. Moreover, the following explanation is an exemplification. FIG. 1 is a drawing showing a configuration of a vehicle equipped an engine for driving a generator. This vehicle is an electric vehicle 1. Although its illustration is omitted, the electric vehicle 1 comprises a normal charger or a charging plug that can charge electric power to a battery 22 by a boosting charger. The electric vehicle 1 also is equipped with a range extender device 4 to extend a driving distance.

As shown in FIG. 1, the electric vehicle 1 comprises a motor 21 for driving, a battery 22, and an inverter 23. The battery 22 accumulates electric power for driving. The battery 22 consists of a lithium ion battery, for example. The motor 21 receives electric power supply from the battery 22 through the inverter 23. The motor 21 drives driving wheels that are front wheels 31 in the example of FIG. 1, and the electric vehicle 1 further comprises rear wheels 32. By driving the front wheels 31, the electric vehicle 1 is propelled. The motor 21 also functions as a generator when decelerating. The battery 22 is charged by regenerative electric power.

The range extender device 4 comprises a generator 41, an engine 42 for driving the generator 41, and a fuel tank 43 for storing fuel to supply to the engine 42. Although its illustration is omitted, the range extender device 4 is unitized and mounted on the rear part of the electric vehicle 1.

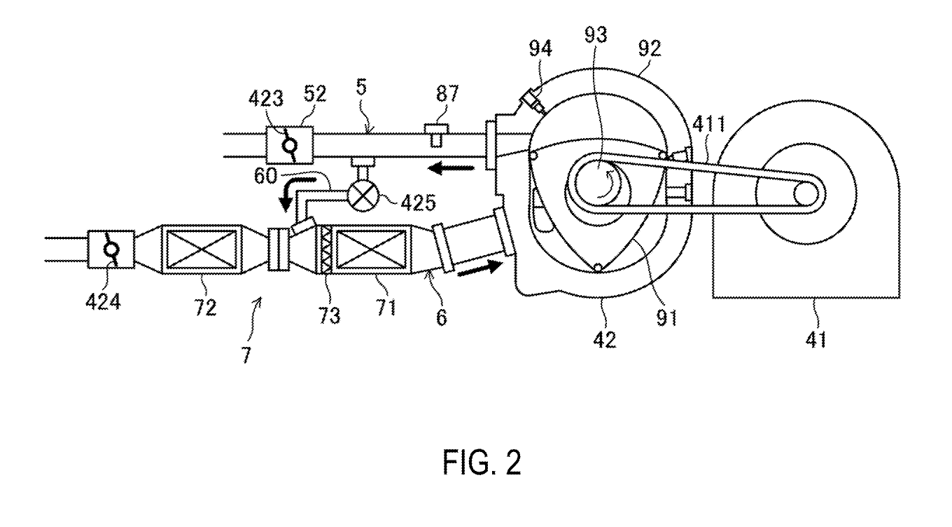

An output shaft of the generator 41 and an output shaft of the engine 42 are mutually connected through an endless body 411 such as a belt, as shown in FIG. 2. The generator 41 generates electric power to charge the battery 22. The electric power generated by driving the generator 41 is sent to the battery 22 through the inverter 23 including a converter. The generator 41 also functions as a starter when starting the engine 42 by driving with the electric power supplied from the battery 22, as described below.

The engine 42 in this example is a small sized rotary piston engine with one rotor. The engine 42 is driven with receiving fuel supply from the fuel tank 43. By driving the engine 42, the generator 41 performs power generation by driving. The fuel tank 43 of the range extender device 4 is limited to a predetermined capacity.

The engine 42 comprises a rotor 91 of approximately triangular shape, a rotor housing 92 for accommodating the rotor 91, and a rotor housing 92, and a pair of side housing to sandwich the rotor housing 92 and divide a rotor housing chamber. By executing each stroke of an intake, a compression, an expansion, and an exhaust in each three working chambers that is formed between a trochoid inner peripheral surface of the rotor housing 92 and the rotor 91, the turning effort of the rotor 91 is generated. The turning effort of the rotor 91 is output from the eccentric shaft 93 that is an output shaft of the rotary piston engine.

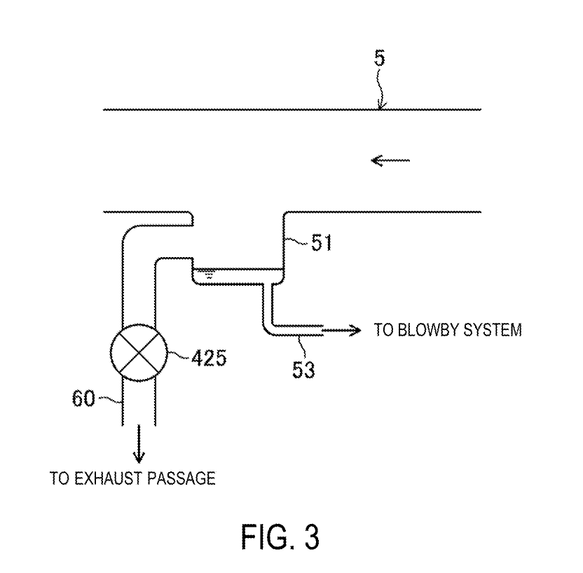

An intake passage 5 and an exhaust passage 6 are connected to the engine 42. In the middle of the intake passage 5, a throttle body 52 to accommodate the throttle valve 423 (refer to FIG. 3) is interposed.

In the middle of the exhaust passage 6, a catalyst device 7 is interposed. The catalyst device 7 comprises a front stage catalyst part 71 that is provided on the upstream side of the exhaust passage 6 (that is, near the engine 42) and a rear stage catalyst part that 72 that is provided on the downstream side of the front stage catalyst part. The front stage catalyst part 71 and the rear stage catalyst part 72 accommodate three-way catalyst respectively. An EHC (Electrically Heated Catalyst) 73 that is an electric heater is provided between the front stage catalyst part 71 and the rear stage catalyst part 72. In detail, the front stage catalyst part 71 and the EHC 73 are integrated. On the exhaust passage 6, an exhaust shutter valve 424 is provided on the downstream of the rear stage catalyst part 72.

The intake passage 5 and the exhaust passage 6 are mutually connected through the EGR (Exhaust Gas Recirculation) passage (that is, a connecting passage) 60. One end of the EGR passage 60 is connected at a position between the throttle body 52 and the engine 42 on the intake passage 5. Another end of the EGR passage 60 is connected at a position between the front stage catalyst part 71 and the rear stage catalyst part 72 on the exhaust passage 6. In more detail, another end of the EGR passage 60 is connected downstream of the EHC 73. In the middle of the EGR passage 60, an EGR valve 425 is interposed to adjust the flow rate of gas flowing in the EGR passage 60. The EGR passage 60, at the normal driving of the engine 42, as required (for example, to reduce the combustion temperature), functions as a passage to reflux the exhaust gas flowing in the exhaust passage 6 to the intake passage 5, and the EGR valve 425 functions as a flow rate adjusting valve to adjust the EGR reflux rate.

As enlarged and shown in FIG. 3 herein, a storage part 51 is formed at the connecting part between the intake passage 5 and the connecting passage 60 to store the oil mist. The upper end part of the storage part 51 opens to the intake passage 5 and the storage part 51 is configured to be a spatial part of a predetermined volume that has a bottom surface on its lower end part. One end of EGR passage 60 opens into the storage part 51 at a position upward of the bottom surface of the storage part 51. Although the details will be described below, when motoring the engine 42 in the reverse rotation direction, as shown by arrows in FIG. 3, the oil mist that is included in the flow of the gas flowing from the intake passage 5 through the EGR passage 60 to the exhaust passage 6 accumulates on the bottom of the storage part 51. Since the EGR passage 60 opens at the higher position than the bottom surface of the storage part 51, the oil mist accumulated in the storage part 51 is prevented from flowing toward the EGR passage 60. An oil pipe 53 that connects to a blowby system (not shown) is also connected to the bottom surface of the storage part 51. The oil accumulated in the storage part 51 is sent to the blowby system through the oil pipe 53.

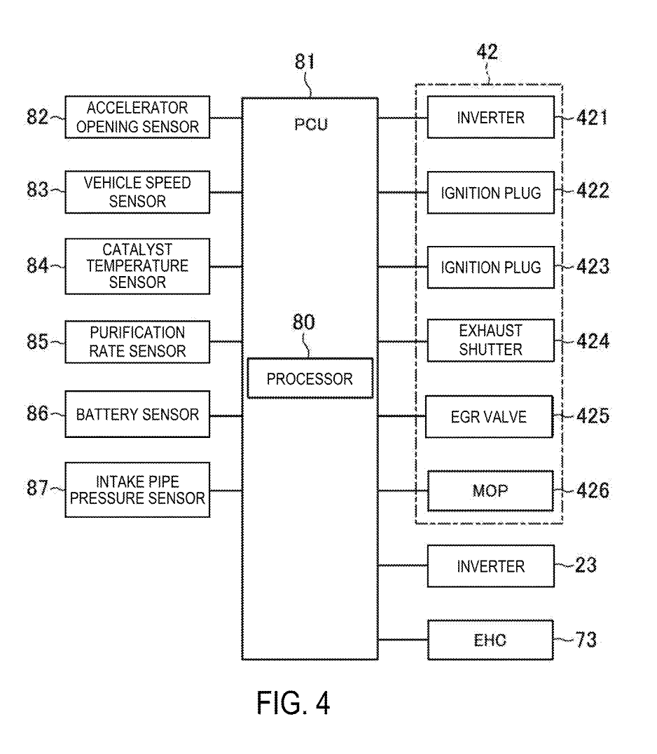

FIG. 4 shows a configuration that relates to a driving control of an electric vehicle 1 equipped a range extender device 4. The electric vehicle 1 comprises a PCU (Powertrain Control Unit) 81 as a control unit including a processor 80 configured to execute instructions stored in non-volatile memory (not shown). An accelerator opening sensor 82 for detecting an accelerator opening degree, a vehicle speed sensor 83 for detecting a vehicle speed, a catalyst temperature sensor 84 for detecting the catalyst temperature of the front stage catalyst part 71 and the rear stage catalyst part 72, a purification rate sensor 85 configured by an O2 sensor for detecting the purification rate of the catalyst device 7, a battery sensor 86 for detecting the SOC (State Of Charge) of the battery 22, and an intake pipe pressure sensor 87 (also refer to FIG. 2) provided on the intake passage 5 are connected to the PCU 81. Sensors 82 to 87 output the detection signals to the PCU 81, respectively. The intake pipe pressure sensor 87 here detects the gas temperature in the intake passage 5 as well as the pressure in the intake passage 5, and outputs the pressure and the temperature to the PCU 81.

To control the engine 42, the PCU 81 outputs control signals to an injector 421 configured to inject fuel being supplied into the working chamber, an ignition plug 422 configured to ignite the air fuel mixture in the working chamber, the throttle valve 423 configured to adjust the air amount that the engine 42 intakes, the exhaust shutter valve 424 provided on the exhaust passage 6 as described above, the EGR valve 425 to adjust the gas flow rate flowing in the EGR passage 60, an electric metering oil pump (Metering Oil Pump: MOP) 426 to supply the metering oil into the working chamber through a nozzle 94 (refer to FIG. 2) in order to ensure the lubrication of the apex seal and the airtightness to keep the airtight of the working chamber that is formed between the rotor 91 and the rotor housing 92 of the engine 42. The PCU 81 also outputs control signals to the inverter 23 and controls the motor 21 and the generator 41 through the inverter 23. The PCU 81, moreover, controls ON/OFF of the EHC 73.

Hereinafter, a driving control of the electric vehicle 1 by the PCU 81 will be briefly explained. The PCU drives the inverter 23 through the motor 21 based on the accelerator opening degree, the vehicle speed, and the like. Accordingly, the electric vehicle 1 is propelled in response to a driver's requests.

The PCU 81 starts the engine 42 and power generation by the generator 41 (that is, execute the power generating operation mode) when the SOC of the battery 22 becomes less than a predetermined value (for example, the predetermined value that is appropriately set to less than 10%). When starting the engine 42, by driving the generator 41 as a prime motor by suppling electric power to the generator 41, it is used as a starter. After starting the engine 42, the PCU 81 drives the engine 42 with a predetermined load and rotation speed so as to perform power generation efficiently by the generator 41. When the generator 41 performs power generation, the engine 42 is driven in a high load and high rotation state. The PCU 81 drives the engine 42 so that the SOC of the battery 22 maintains the predetermined value.

The electric vehicle 1 equipped with the range extender device 4 starts power generation by starting the engine 42 only when the SOC of the battery 22 is reduced to the predetermined value. The number of starts of the engine 42 on the electric vehicle 1 is relatively low. Since the number of starts of the engine 42 is low, the start of the engine 42 is easily a cold start, and in most cases, the catalyst device 7 is inactive when the engine 42 starts. Thus, when starting the engine 42, the emission amount that is exhausted into the atmosphere may possibly be increased.

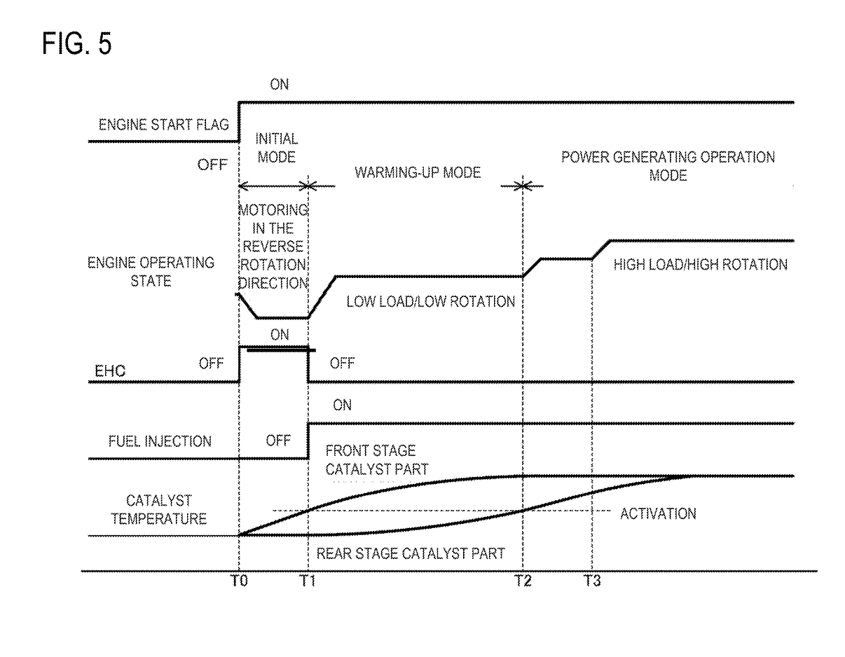

Therefore, the electric vehicle 1 equipped with this range extender device 4 is configured to control the emission exhausted at the start time of the engine 42. The control executed by the PCU 81 at the start time of the engine 42 will be explained with reference to a timing diagram shown in FIG. 5.

It is assumed that a start flag of the engine 42 turns from OFF to ON at the time T0. Thus, when the SOC of the battery 22 is reduced to the predetermined value, the start flag turns ON. When the start flag turns ON, in order to start power generation by the generator 41, the engine 42 starts.

When starting the engine 42, the initial mode is executed. The initial mode is a mode for the purpose of mainly activating the front stage catalyst part 71. In the initial mode, the PCU 81 turns the EHC 73 ON, so that the front stage catalyst part 71 adjacent to the EHC 73 is heated. At this time, in order to heat the front stage catalyst part 71 efficiently, the PCU 81 supplies electric power to the generator 41. By driving the generator 41 as a prime motor, motoring of the engine 42 is performed. Thus, the engine 42 is idled to run without combusting. When also motoring the engine 42, as well as at the normal driving of the engine 42, the PCU 81 drives the MOP 426 and supplies metering oil to the sealing face in the rotary piston engine.

The generator 41, as shown by arrows in FIG. 2, performs motoring of the engine 42 in the reverse rotation direction. Moreover, the PCU 81 fully closes the throttle valve 423 and the exhaust shutter valve 424 respectively and fully opens the EGR valve 425. Accordingly, a closed passage is configured to return from the engine 42 through the intake passage 5, the EGR passage 60, and the exhaust passage 6 to the engine 42. In this way, as shown by arrows in FIG. 2, in the initial mode, gas circulates to return from the intake side of the engine 42 through the intake passage 5, the EGR passage 60, the EHC 73, the front stage catalyst part 71, and the exhaust passage 6 to the engine 42. By this gas flow, the heat of the EHC 73 is sent efficiently to the front stage catalyst part 71 and the temperature of the front stage catalyst part 71 is promptly raised. Moreover, since the gas flow circulates in the closed passage, the gas temperature is gradually increased and the temperature of the front stage catalyst part 71 is promptly raised. The front stage catalyst part 71 is led to be activated.

The metering oil is supplied in the engine 42 during motoring here, the gas exhausted from the engine 42 to the intake passage includes relatively a large amount of the oil mist. The oil mist in the gas adheres to a wall surface of the intake passage 5 or accumulates in the storage part 51 provided on the intake passage 5. The oil adhered to the wall surface of the intake passage 5 is introduced into the engine 42 with intake air when driving the engine 42. Moreover, the oil accumulated in the storage part 51 is sent to the blowby system through the oil pipe 53. In this way, by circulating the gas flow during motoring in the reverse direction, the oil mist in the engine 42 can be controlled from entering the catalyst device 7. This is advantageous in controlling the deterioration of the catalyst device 7.

Moreover, in the middle of executing the initial mode, the PCU 81 determines whether the gas temperature in the intake passage 5 becomes high or not compared to before executing the initial mode based on the detection signal from the intake pipe pressure sensor 87. This determination pertains to the fault determination of the EHC 73. For example, when passing the predetermined time after starting the initial mode, if the gas temperature rise amount is greater than or equal to the predetermined threshold value, the EHC 73 is determined to be normally driven, and if the gas temperature rise amount is less than the predetermined threshold value, the EHC 73 is determined to not be normally driven. When the EHC 73 is determined to not be normally driven, although its illustration is omitted, for example, the PCU 81 lights a warning lamp provided on the meter cluster panel.

At the time T1, the PCU 81 starts the engine 42. At this time, since motoring of the engine 42 is performed in the reverse rotation direction by the generator 41, the PCU 81, at first, rotates the engine 42 in the normal rotation direction by the generator 41. In this situation, the fuel injection is started by the injector 421 and the ignition plug 422 is driven at the predetermined timing. In this way, the engine 42 can be started smoothly and certainly. The PCU 81 also closes the EGR valve 425 as well as opens the throttle valve 423 and the exhaust shutter valve 424 respectively when starting the engine 42. Moreover, the PCU 81 turns the EHC 73 OFF. At the time T1, the initial mode terminates and a warming-up mode described below starts.

At the time T1, the temperature of the front stage catalyst part 71 reaches an activation temperature. A duration of the initial mode (that is, T1-T0) is predetermined and then the PCU 81 may terminate the initial mode and start the warming-up mode by a timer when the predetermined duration of the initial mode passes. The duration of the initial mode may be properly set according to the capacity of the EHC 73 and/or the operating state of the EHC 73 in the initial mode (that is the supply electric power to the EHC 73). The duration of the initial mode may be set for example, from about ten seconds to about several tens of seconds. The generator 41 functions as a starter. Moreover, the PCU 81 may terminate the initial mode and start the warming-up mode based on the detection of the temperature state of the catalyst device 7.

In the warming-up mode after starting the engine 42, the PCU 81 rotates the engine 42 with low load and low rotation. The output of the engine 42 at this time is made lower than the power generation drive when the generator 41 described below practically performs power generation. In the warming-up mode, by making the power generation by the generator 41 lower than the predetermined power generation amount, the catalyst device 7, especially the rear stage catalyst part 72, is activated. Since the exhaust gas exhausted from the started engine 42 is sent to the front stage catalyst part 71 and the rear stage catalyst part 72, the temperatures of the front stage catalyst part 71 and the rear stage catalyst part 72 are gradually increased. In the warming-up mode, since the output of the engine 42 is low while the front stage catalyst part 71 is activated, the degradation of the emission performance is prevented and also the rear stage catalyst part 72 is activated.

As the operating state of the engine 42 in the warming-up mode, in regards to load, when the load range of the engine 42 is divided into two ranges of a low load range and a high load range, it may be driven in a low load range. In regards to the rotation speed, when the rotation speed range of the engine 42 is divided into three ranges of a low rotation speed range, an intermediate rotation speed range, and a high rotation speed range, it may be driven in the low rotation speed range. In regards to the rotation speed, when the rotation speed range of the engine 42 is divided into two ranges of the low rotation speed range and the high rotation speed range, it may be driven in the low rotation speed range. The engine 42 may be driven at, for example, 1200 to 1800 rpm.

Then, at the time T2, the PCU 81 terminates the warming-up mode and starts the power generating operation mode. At the time T2, the temperature of the rear stage catalyst part 72 reaches the activation temperature. A duration of the warming-up mode (that is, T2-T1) is predetermined and then the PCU 81 may terminate the warming-up mode and start the power generating operation mode by a timer when the predetermined duration of the warming-up mode passes. The duration of the warming-up mode may be properly set according to the operating state of the engine 42 in the warming-up mode. The duration of the warming-up mode may be set for example, from about ten seconds to about several tens of seconds. Moreover, the PCU 81 may terminate the warming-up mode and start the power generating operation mode based on the detection of the temperature state of the catalyst device 7.

The power generating operation mode is a mode that the generator 41 performs the predetermined (substantial) power generation. The PCU 81 changes the operating state of the engine 42 from the low load and low rotation state to the high load and high rotation state. The output of the engine 42 is increased more than that in the warming-up mode (for example, the power generation drive performs power generation of 10 to 30 KW) and becomes the power generation drive, so that the power generation is performed efficiently by the generator 41. Since both of the front stage catalyst part 71 and the rear stage catalyst part 72 are in the active state, even though the engine 42 is driven in the high load and high rotation state, the emission performance is not deteriorated.

As the operating state of the engine 42 in the power generating operation mode, in regards to the load, when the load range of the engine 42 is divided into two ranges of the low load range and the high load range, it may be driven in a high load range. The engine 42 may be driven in the full load state. In regards to the rotation speed, when the rotation speed range of the engine 42 is divided into two ranges of the low rotation speed range and the high rotation speed range, it may be driven in the high rotation speed range. The engine 42 may be driven at for example, 4000 to 5000 rpm. The engine 42 may be driven with the rated rotation speed. The characteristics of the generator 41 and the engine 42 may be set respectively so as to perform power generation efficiently at the maximum output time of the engine 42.

Soon after switching from the warming-up mode to the power generating operation mode, the PCU 81 gradually increases the output of the engine 42 in consideration of the purification rate of the catalyst device 7 based on the detection signal of the purification rate sensor 85. In an example in FIG. 4, the engine 42 is driven so that the engine output is higher than that in the warming-up mode until the time T3, and is lower than that with the above described high load and high rotation after the time T3. In this way, the degradation of the emission performance is prevented. The generator 41 performs power generation also between the time T2 and the time T3. However, compared with after the time T3, the power generation capacity of the generator 41 becomes low. Moreover, not based on the detection of the purification rate of the catalyst device 7, a period is predetermined (T3-T2), by using a timer the engine output is set relatively low until the predetermined period passes and the engine output is set high after the predetermined period passes.

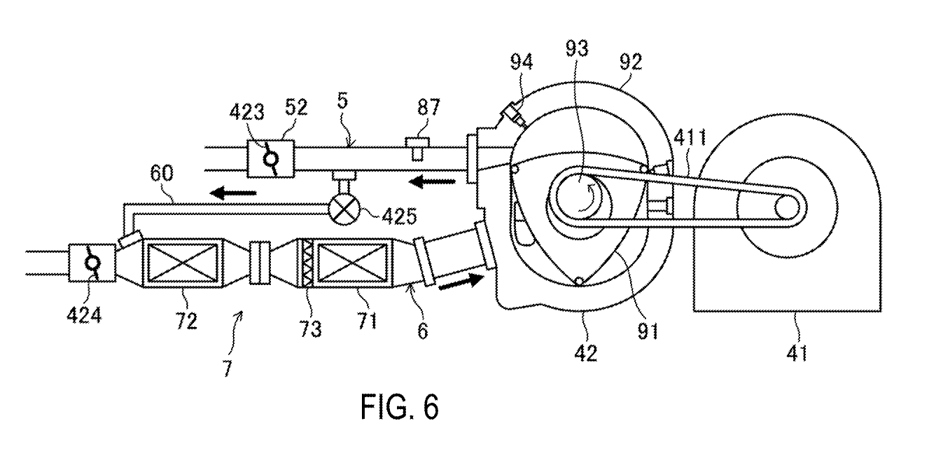

A variation example of the range extender device is explained as follows. FIG. 6 shows a configuration example of the range extender device 4 that is different from that in FIG. 2. The range extender device 4 in FIG. 6 has a different configuration of the EGR passage 60. Specifically, the other end of the EGR passage 60 is connected downstream of the rear stage catalyst part 72 on the exhaust passage 6.

In this configuration example of the range extender device 4, according to the timing diagram shown in the FIG. 5, the engine 42 at the start time is controlled. That is, in the initial mode, the generator 41 performs motoring of the engine 42 in the reverse rotation direction. Accordingly, the gas circulates so as to return from the intake side of the engine 42 through the intake passage 5, the EGR passage 60, the rear stage catalyst part 72, the EHC 73, the front stage catalyst part 71, and the exhaust passage 6 to the engine 42.

As explained above, the vehicle equipped with the engine for driving the generator disclosed herein (that is, an electric vehicle 1 equipped with a range extender device 4) comprises a generator 41 mounted to the vehicle for generating electric power for driving, an engine 42 connected to the generator 41 for driving the generator 41, a catalyst device 7 provided on an exhaust passage 6 of the engine 42 for purifying the exhaust gas exhausted from the engine 42 when operating the engine 42, an electric heater (that is, EHC 73) provided on the exhaust passage 6 for heating the catalyst device 7, and a control unit (that is, PCM 81) for executing a power generating operation mode to drive the generator 41 by driving the engine 42 after executing an initial mode to activate the catalyst device 7 by operating the EHC 73 when the generator 41 starts power generation by starting the engine 42.

The EHC 73 is provided downstream of the catalyst device 7, and the generator 41 is configured to drive the engine 42. The vehicle also comprises a connecting passage (that is, an EGR passage 60) for mutually connecting an intake passage 5 and the exhaust passage 6 of the engine 42, and an adjusting valve (that is, a throttle valve 423, an exhaust shutter valve 424, and an EGR valve 425) for adjusting a gas flow rate flowing in the connecting passage 60.

Moreover, the PCM 81 performs motoring of the engine 42 in a reverse rotation direction by the generator 41 while driving the EHC 73 in the initial mode and adjusting the gas flow rate flowing in the EGR passage 60 by the throttle valve 423, the exhaust shutter valve 424, and the EGR valve 425.

In this configuration, in the initial mode, the engine 42 is not driven, so that the degradation of the emission performance is prevented. In the initial mode, the gas circulates so as to return from the engine 42 through the intake passage 5, the EGR passage 60, and the exhaust passage 6 to the engine 42. By circulating the gas, the catalyst device 7 can be raised in temperature efficiently and the catalyst device 7 can be activated early.

Moreover, by making the gas circulation flow in the initial mode in the reverse direction at the time of the normal operation of the engine 42, the floating oil mist in the engine 42 is exhausted to the intake passage 5 side when motoring the engine 42. Accordingly, introduction of the oil mist to the catalyst device 7 is controlled and preventing the deterioration of the catalyst device 7 is possible.

Since the engine 42 is preferably a rotary piston engine that is configured to supply metering oil to a sealing face in the engine 42, the metering oil needs to be supplied to the sealing face in the engine 42 also when motoring in the initial mode. In the initial mode, when motoring the rotary piston engine, the oil mist amount in the engine becomes larger than that of the reciprocating engine. Therefore, when motoring in the initial mode, motoring the rotary piston engine in the reverse rotation direction is especially effective at preventing oil mist from entering the catalyst device 7.

In the initial mode, after activating the catalyst device 7, the engine 42 is operated and the power generating operation mode to drive the generator is executed. In the power generating operation mode, since the purification rate of the catalyst device 7 is increased, the degradation of the emission performance is prevented even if the engine 42 is operated.

Accordingly, on the range extender electric vehicle, when starting the power generation of the generator 41 by starting the engine 42, the degradation of the emission performance is prevented. Moreover, the power generation of the generator 41 can be started promptly.

A temperature sensor is provided on the intake passage 5 for detecting the temperature of the gas flowing in the intake passage 5 (that is, an intake pipe pressure sensor 87), and the PCM 81 detects a failure of the EHC 73 based on a detection result of the intake pipe pressure sensor 87 during the execution of the initial mode.

Accordingly, the fault determination of the EHC 73 related to the exhaust emission performance is possible during executing the initial mode before starting the engine 42. Moreover, the sensor for detecting the temperature of the gas flowing in the intake passage 5 is not limited to use the intake pipe pressure sensor 87, and other sensors may be utilized. Furthermore, during executing the initial mode, the temperature sensor for detecting the temperature of the gas flowing in the intake passage 5 may be provided separately.

The catalyst device 7 comprises a front stage catalyst part 71 and a rear stage catalyst part 72 that is provided downstream of the front stage catalyst part 71, the EHC 73 is provided between the front stage catalyst part 71 and the rear stage catalyst part 72, and the PCM 81 executes the power generating operation mode after the front stage catalyst part 71 achieves an active state in the initial mode.

By providing the EHC 73 between the front stage catalyst part 71 and the rear stage catalyst part 72, by the gas circulation flow in the initial mode, the front stage catalyst part 71 that is directly upstream of the EHC 73 can be activated early.

Then, after the front stage catalyst part 71 is activated, by executing the power generating operation mode that drives the engine 42, the degradation of the emission performance is controlled. Moreover, the power generation of the generator 41 can be started promptly.

The EGR passage 60, as shown in the configuration example in FIG. 2, is connected between the front stage catalyst part 71 and the rear stage catalyst part 72 on the exhaust passage 6. In this way, in the initial mode, since the gas circulates also in the front stage catalyst part 71, the front stage catalyst part 71 is activated. In this configuration, since the path length that the gas circulates is relatively short in the initial mode, the front stage catalyst part 71 can be activated effectively. As a result, the time of the initial mode can be shortened. This is advantageous in downsizing the EHC 73.

Moreover, as shown in the configuration in the FIG. 2, when circulating the gas in the initial mode, the exhaust shutter valve 424 can be omitted if the downstream side of the exhaust passage 6 is becomes the same state as though the exhaust shutter valve 424 were closed, through resistance of the rear stage catalyst part 72.

The EGR passage 60, as shown in the configuration example in FIG. 6, is connected downstream of the rear stage catalyst part 72 on the exhaust passage 6. In this way, in the initial mode, since the gas circulates in rear stage catalyst part 72 and also the front stage catalyst part 71, the rear stage catalyst part 72 and the front stage catalyst part 71 are activated respectively. Moreover, during the normal driving of the engine 42, when refluxing the exhaust gas through the EGR pass 60 to the intake passage 5, the exhaust gas of the further lowered temperature can be refluxed to the intake passage 5. This is advantageous in decreasing the combustion temperature.

A storage part 51 is provided between a cylinder inlet of the engine 42 and a connecting part of the EGR passage 60 on the intake passage 5 for storing the oil mist.

In this way, the oil mist exhausted to the intake passage 5 side reaches the exhaust passage 6 from the EGR passage 60, and introduction thereof to the EHC 73 and/or the catalyst device 7 is controlled.

When starting the power generating operation mode, the PCM 81 starts fuel supply to the engine 42 after motoring the engine 42 in the normal rotation direction via the generator 41. Accordingly, the engine 42 can be started smoothly and certainly from the state of motoring the engine 42 in the reverse rotation direction.

In the warming-up mode here, the generator 41 may perform power generation at the degree to which it hardly generates any power (for example, the 1 KW degree of power generation). Moreover, the warming-up mode may be omitted. That is, if the front stage catalyst part 71 is activated in the initial mode, the power generating operation mode may be executed. In this case, by gradually increasing the output of the engine 42 from the lower output than the engine output that is set in the power generating operation mode, the power generation by the generator 41 starts gradually.

Moreover, in the configuration, although the catalyst device 7 comprises two catalyst parts of the front stage catalyst part 71 and the rear stage catalyst part 72, the catalyst part may be one.

In the configuration, although the EGR passage 60 is used as the connecting passage for connecting between the intake passage 5 and the exhaust passage 6, a connecting passage may be provided separately from the EGR passage. Moreover, in an engine system that does not comprise the EGR passage 60, only the connecting passage may be provided. Furthermore, an EGR cooler may be inserted in the EGR passage 60.

Additionally, in the configuration, although the engine 42 is a rotary piston engine, it may be a reciprocating engine.

The technology disclosed herein is not limited to be applied to the electric vehicle 1 equipped with the range extender device, but may also be applied to the so-called plug-in hybrid vehicle. Thus, when the SOC of the battery is reduced for the first time, on the vehicle of which the engine 42 starts for starting power generation by the generator 41, at the start time of the engine 42, the catalyst device 7 is mostly inactive. Since the degradation of the emission performance can be prevented at the start time of the engine 42, the technology disclosed herein is also suitable for a plug-in hybrid vehicle.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### LIST OF REFERENCE CHARACTERS

1 Electric vehicle (vehicle)
21 Motor (Driving motor)
22 Battery
41 Generator
42 Engine
6 Exhaust passage
7 Catalyst device
71 Front stage catalyst part
72 Rear stage catalyst part
73 EHC (Electric heater)
81 PCU (control unit)

What is claimed is:

1. A vehicle equipped with an engine for driving a generator, comprising:
a generator mounted to the vehicle for generating electric power for driving;
an engine connected to the generator for driving the generator;
a catalyst device provided on an exhaust passage of the engine for purifying the exhaust gas exhausted from the engine when operating the engine;
an electric heater provided on the exhaust passage for heating the catalyst device;
a control unit including a processor for executing a power generating operation mode to drive the generator by driving the engine after executing an initial mode to activate the catalyst device by operating the electric heater when the generator starts power generation by starting the engine;
a connecting passage for mutually connecting an intake passage and the exhaust passage of the engine; and
an adjusting valve for adjusting a flow rate of the gas flowing in the connecting passage;
wherein the electric heater is provided downstream of the catalyst device, the generator is configured to drive the engine, and the control unit is configured to execute motoring of the engine in a reverse rotation direction via the generator while the electric heater is operated in the initial mode and adjusting the gas flow rate in the connecting passage via the adjusting valve.

2. The vehicle equipped with an engine for driving a generator according to claim 1, further comprising:
a temperature sensor provided on the intake passage for detecting a temperature of the gas flowing in the intake passage,
wherein the control unit is configured to detect a failure of the electric heater based on a detection result of the temperature sensor during the execution of the initial mode.

3. The vehicle equipped with an engine for driving a generator according to claim 1,
wherein the catalyst device comprises a front stage catalyst part and a rear stage catalyst part that is provided downstream of the front stage catalyst part, the electric heater is provided between the front stage catalyst part and the rear stage catalyst part, and the control unit executes the power generating operation mode after the front stage catalyst part achieves an active state in the initial mode.

4. The vehicle equipped with an engine for driving a generator according to claim 3,
wherein the connecting passage is connected downstream of the rear stage catalyst part on the exhaust passage.

5. The vehicle equipped with an engine for driving a generator according to claim 3,
wherein the connecting passage is connected between the front stage catalyst part and the rear stage catalyst part on the exhaust passage.

6. The vehicle equipped with an engine for driving a generator according to claim 1, further comprising:
a storage part provided between a cylinder inlet of the engine and a connecting part of the connecting passage on the intake passage for storing oil mist.

7. The vehicle equipped with an engine for driving a generator according to claim 1,
wherein the engine is a rotary piston engine that is configured to supply metering oil to a sealing face in the engine.

8. The vehicle equipped with an engine for driving a generator according to claim 1,
wherein the control unit starts to supply fuel to the engine after motoring the engine in a normal rotation direction by the generator when starting the power generating operation mode.
